(19) United States
(12) Patent Application Publication
(10) Pub. No.: US 2004/0135402 A1
(43) Pub. Date: Jul. 15, 2004

(54) Method for the manufacture of a roof liner with at least one energy absorption element and the corresponding roof liner

(76) Inventors: Bernd Glunk, Ebersberg (DE); Armin Schmauss, Grafing (DE)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/706,614

(22) Filed: Nov. 12, 2003

(30) Foreign Application Priority Data
Nov. 12, 2002 (DE) 10252603.6

(51) Int. Cl. B60R 13/02

(52) U.S. Cl. 296/214

(57) ABSTRACT

In order to improve a roof liner with at least one energy absorption element to the effect that the energy absorption element can be reproducibly applied to a particular place of the roof liner with the intended alignment relative to the roof liner in a simple and economical way, first a core layer, particularly a plate-shaped one, is provided, at least one reinforcement layer is applied to this on at least one side and the energy absorption element is loaded into a moulding tool and, during the moulding, the energy absorption element and the core layer and/or reinforcement layer are at least joined.

From practical applications, a number of roof liners for a motor vehicle are known that are constructed in the widest variety of ways. As a rule, the roof liner presents a layered structure and includes at least a core layer as a supporting base, a reinforcement layer applied to one side of the core layer and a decorative layer facing the vehicle passenger compartment. Different openings or components can be provided in the roof liner, whereby the openings serve for the attachment of a sun visor, handles or the like, for example. The components could be a light, switch, link circuits or the like, for example. The roof liner is attached in the vehicle to a body roof, from the inside. At the same time, such a roof liner can be self-supporting and is, for example, only fixed in place, particularly detachably, to different places on the body essentially along its edge. The roof liner can also be fixed in place in a way that it is not detachable, for example, by lifting.

When a passenger impacts against the roof liner, it should present an absorption effect that is sufficient for the energy transmitted by the impact. This occurs, on the one hand, because of the design of the roof liner, whereby this can present an energy-absorbing layer, for example. As a rule, however, the roof liner is relatively thin and the energy absorption by the roof liner itself is only partially sufficient. For this reason, additional energy absorption elements are arranged on the roof liner, preferably on its upper side that faces the body roof or also directly on the body, between it and the roof liner. These energy absorption elements are called crash pads. If such crash pads are mounted directly on the roof liner, until now they have been mounted manually, after the completion of the roof liner, which is to say also after the roof liner's corresponding shaping for the adaptation to the body, for example, by gluing. This manual method is relatively time-consuming and costly.

In addition, it is not ensured that the crash pads are always mounted on the same place on the roof liner or that corresponding crash pads are arranged in the corresponding position. For example, the crash pads can present different thicknesses or also length or width dimensions, which vary depending on the mounting position on the roof liner, whereby a particular crash pad must be mounted at the appropriate place on the roof liner. With manual attachment, it is easy for corresponding crash pads to be incorrectly coordinated with the roof liner.

The object of the invention is to provide an improved method for the manufacture of a roof liner with at least one energy absorption element, to the effect that the energy absorption element (crash pad) is reproducibly mounted at a particular place on the roof liner with the intended alignment relative to the roof liner, in a simple and economical way.

This object is solved by means of the features of patent claim 1.

A corresponding roof liner manufactured according to this method is particularly distinguished by the features of patent claim 13.

According to the invention, the roof liner is manufactured with an energy absorption element in an automatic process, without manual attachment or alignment of the crash pad to or with the roof liner being necessary. In this process, according to the invention, the crash pad is loaded directly into a moulding tool, in which the supporting base, formed at least from the core layer, is subsequently moulded. During this moulding with optional additional shaping, a joining of the energy absorption element and core layer simultaneously takes place. If one or more reinforcement layers have already been applied to the core layer, the joining of the energy absorption element and corresponding reinforcement layer takes place during the moulding.

By loading the energy absorption element directly into the moulding tool, the result is an exactly reproducible coordination with and also alignment to the roof liner. This coordination and alignment are guaranteed even if there is more than one energy absorption element. The loading of the energy absorption elements into the moulding tool can likewise be done automatically, so that essentially no manual activity is necessary during mass production for roof liners. As already explained, according to the invention there is also the possibility that the corresponding energy absorption element(s) is/are arranged between the core layer and reinforcement layer, whereby the reinforcement layer is also correspondingly loaded into the moulding tool and, together with the energy absorption element, is joined to and shaped with the core layer. Accordingly, attachment to a sandwich of core layer and reinforcement layer is possible.

In order to be able to apply the decorative layer subsequent to or simultaneously with the application of the energy absorption element, this decorative layer is applied with at least one side, as a rule, to a side facing the passenger compartment, of a sandwich formed from at least the core layer and reinforcement layer. Also in this connection, loading and attachment of the energy absorption element in the moulding tool is possible.

In order to adapt the roof liner according to the inside roof lining of the body and other parts of the body, which it covers after being attached, at least the core layer and optionally also the reinforcement layer can be permanently plastically shaped during the moulding of the supporting base.

The essentially plate-shaped core layer can already be appropriately prefabricated, so that it is provided directly for the manufacture of the roof liner. In this way, the core layer, for example, can be delivered by a separate manufacturer, so that, at the actual roof liner manufacturer, no additional work needs to be carried out on the core layer and it can be directly fed to the further fabrication into a roof liner.

Likewise, it is possible that the core layer, before being provided, is cut from a prefabricated core layer block as a plate.

In this connection, there is furthermore the possibility that the core layer is foamed from an appropriate material directly before it is provided for the manufacture of the roof liner.

In order to avoid a negative influence on the visual impression of the decorative layer when attaching the energy absorption element where necessary, which could, for example, result from a part of the core layer or reinforcement layer being pressed in the direction of the decorative layer during the attachment of the energy absorption element, the energy absorption element is attached before the application of the decorative layer and subsequent to the application of the reinforcement layer. If such extrusion of the energy absorption element is not to be feared, however, the energy absorption element can, for example, be applied simultaneously with the decorative layer or after the application of the decorative layer during the laminating moulding when the appropriate supporting base is moulded.

While the roof liner and particularly the core layer should be permanently plastically shaped during the moulding of the supporting base, it is however not necessary that, for example, the core layer be formed from a duroplastic material. Instead, appropriate duroplastic behaviour can be achieved by applying an adhesive and optionally water to the core layer subsequent to the provision of the core layer. Particularly the adhesive serves to realise the duroplastic behaviour of the core layer during the moulding of the supporting base. There is also the possibility of doing without an application of adhesive or water if, for example, foamed polypropylene is used as the material for the core layer.

The reinforcement layer can be constructed as one layer, whereby this is applied to one or both of the top and bottom sides of the core layer. Such two-sided application can occur simultaneously. There is likewise the possibility that a two-layered reinforcement layer, particularly of reinforcement matting and cover matting, is applied. This can also be done on two sides and simultaneously on the top and bottom of the core layer.

In order to be able to attach the decorative layer in a simple manner, an adhesive can be applied to at least one side of the sandwich before applying the decorative layer, subsequent to the joining and/or shaping of the core layer and reinforcement layer and optionally also subsequent to the attachment of the energy absorption element during the moulding of the supporting base. This adhesive particularly serves to secure the decorative layer. There is likewise the possibility that the decorative layer already contains an adhesive.

Because when the decorative layer is applied, the above-mentioned sandwich with energy absorption element has already been correspondingly shaped during the moulding of the supporting base, the decorative layer can be heated before being applied to the sandwich and subsequently be laminated to the sandwich in a laminating machine. As a rule, new or further shaping of the sandwich does not take place during this process.

Subsequent to the application of the decorative layer, the edges of the roof liner can be corrected in the customary way using a stamping machine or the like, or by trimming the edges, crimping, etc.

In order, on the one hand, to ensure both the joining of the core layer and the reinforcement layer as well as the energy absorption element in a simple way during the moulding of the supporting base, heat can simultaneously be added during the moulding of the supporting base, whereby the supporting base is moulded in a hot-press with corresponding supporting base mould tools.

Depending on the material used for the energy absorption element, a fixed shaping of these elements can take place during the moulding of the supporting base, which optionally then automatically recovers again because of the corresponding elasticity of the energy absorption element.

It can, however, also prove to be advantageous if the energy absorption element is also shaped when the supporting base is moulded. This shaping can serve, on the one hand, to compress the energy absorption element in a particular way and/or also be used as a moulded part, which is adapted to openings or the like in the body when it is attached to the body. In this connection, the energy absorption element can also be formed from moulding foam, so that it already presents a particular shaping and only needs to be joined to the sandwich.

In order to prevent an at least partially elastic energy absorption element from recovering after the moulding of the supporting base, the energy absorption element can be shaped and held in its shaped state by a corresponding shape preservation material. Such a shape preservation material can, for example, be an appropriate adhesive or reaction agent, which maintains the shape of the energy absorption element formed when the supporting base was moulded during the heating and shaping of the energy absorption element. The shape preservation material is preferably already applied to the energy absorption element even before it is loaded into the supporting base mould tool. There is likewise also the possibility that instead of using such a shape preservation material, the energy absorption element keeps its shape attained during the moulding of the supporting base because it is arranged between the core layer and reinforcement layer.

Likewise, the invention relates to a roof liner manufactured using the method described. Because of the simple design, economical manufacture and for reasons of improved recycling, this distinguishes itself due to the fact that it presents a core layer of a foamed material and a reinforcement layer with fibres, particularly offset in a tangled arrangement. There is also the possibility of using reinforcement layers with essentially uni-directionally or bi-directionally aligned fibres (weave, scrim), but as a rule, these present worse workability and higher manufacturing costs for the sandwich, at least when it contains polypropylene as the foam material.

The foamed material can, for example, be polyurethane foam or another foamed plastic material.

For energy absorption elements or crash pads, different materials and structures are conceivable. One easy-to-manufacture and easily shaped energy absorption element is formed from an energy-absorbing, foamed material.

There are, however, additional elements or also materials conceivable for the energy absorption element, whereby these can particularly present at least one structure element or be formed from such an element. Such a structure element can, for example, present plastic ribs, plastic honeycombs or the like inserted into the foamed material. Instead of plastic for the ribs or honeycombs, a metal, such as aluminium, sheet metal or the like can likewise be used. Appropriate energy-absorbing foam can be formed from polypropylene, polyurethane or polyester.

If a foam material is used for the energy absorption element, there is likewise the possibility that this foam material is the same as that used for the core layer. During the shaping of the core layer and simultaneous attachment of the energy absorbing element, however, in order to prevent the energy absorbing element, during the corresponding heating of both parts, from pressing too deeply into the core layer and possibly causing projections, bulging or the like on its bottom that faces the decorative layer, the material of the energy absorption element can present a softening temperature that is lower than that of the material of the core layer. In this way, it is ensured that the energy absorption element is appropriately workable at a particular temperature and is joined to the core layer or the reinforcement layer, while at the same time, the core layer is not so softened that this layer is negatively shaped when the energy absorbing element is pressed on, in the sense of an extrusion or the like in the direction of the decorative layer.

In order to be able to apply an appropriate adhesive on the core layer or on the above-mentioned sandwich, the adhesive can be applied to one or both sides on the top and bottom of the core layer or the sandwich by an application device. This application device can, for example, be formed by a spraying device, spreading rolls or the like. In particular, the application device results in a uniform and reproducible application of the adhesive across the surface, whereby the amount of adhesive is well adjustable.

In the following, an advantageous embodiment of the invention is explained in more detail using the figures included with the drawing.

Shown are:

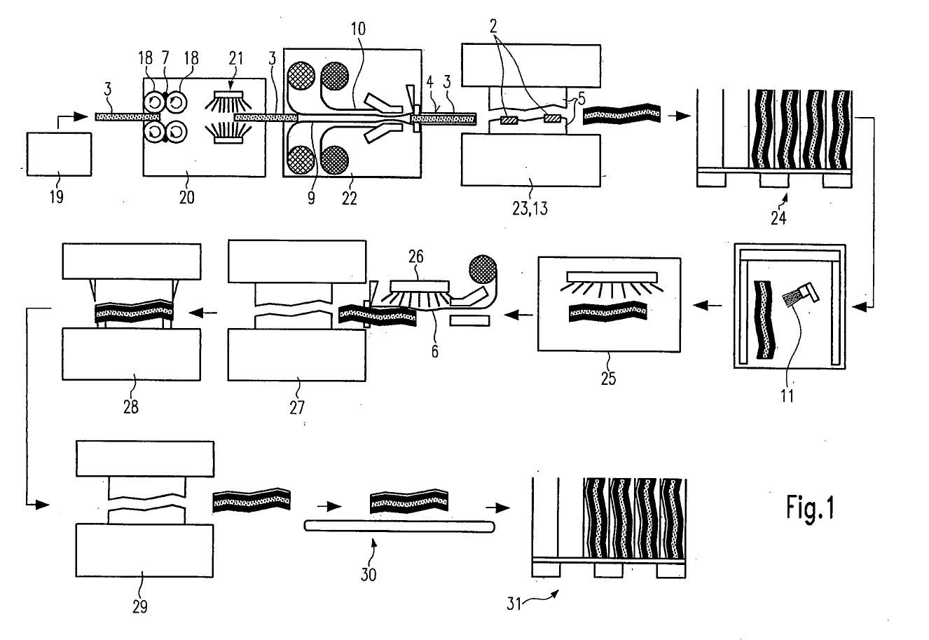

FIG. 1 a representation of different process steps for the manufacture of a roof liner, according to the invention;

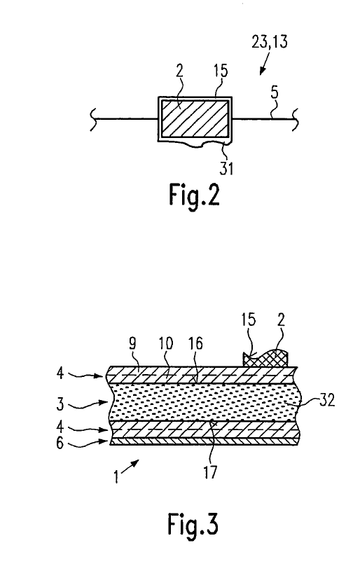

FIG. 2 an enlarged side view of a supporting base mould tool with loaded energy absorption element, and

FIG. 3 a longitudinal section through a roof liner according to the invention, with energy absorption element.

FIG. 1 shows a number of process steps for the manufacture of a roof liner with energy absorption elements according to one embodiment of the invention. A core layer is fed to a first processing station 20 at a supply 19 of essentially plate-shaped core layers. In this first processing station 20, spreading rolls are arranged as the application device 18, which apply an adhesive 7 to both sides of the plate-shaped core layer 3. Subsequently, water is sprayed on to both sides of the core layer 3 in the same processing station by an additional application device 21. In a second processing station 22, a reinforcement matting 9 and a cover matting 10 are likewise fed to both sides of the core layer 3 and pressed on to it. At the same time, the adhesive 7 can already serve for at least partial attachment of the reinforcement layer 4, formed from the cover matting 10 and reinforcement matting 9, to the core layer 3.

In a third processing station 23, which is formed as a hot-press 13, energy absorption elements 2 are loaded into at least the lower part of an appropriate moulding tool 5, here the supporting base moulding tool, in appropriate depressions. In the hot-press 13, the core layer 3 with reinforcement layers 4 is likewise loaded and subsequently shaped and joined to the energy absorption elements 2.

In the following, the energy absorption elements 2 are not depicted for reasons of simplification.

After the supporting base is moulded, the shaped supporting bases, provided with energy absorption elements 2, are usually kept in the storage position 24. For further processing, an additional adhesive 11 is sprayed on to the supporting bases taken from the storage position 24, subsequently followed by a drying process in a drying station 25.

A decorative layer 6 is subsequently fed to the supporting base that has been provided with adhesive on one side, and this decorative layer 6 is then heated with a heating device 26 and subsequently laminated to the supporting base in a laminating machine 27.

Subsequently, there can occur, in the customary way, a stamping of the supporting base that was provided with a decorative layer in a stamping device 28, edge-trimming and crimping in an additional station 29 and corresponding mounting of additional components on the roof liner in a last processing station 30. The then completed roof liner with mounted components is subsequently optionally packed and transported to assembly, see reference number 31.

FIG. 2 shows a side view of a supporting base mould tool 5 in the hot-press 13 as processing station 23. An energy absorption element 2 is loaded into a depression 31 in the supporting base mould tool 5. Core layer 3, see FIG. 1, with reinforcement layer 4 of stiffening matting 9 and cover matting 10 has not yet been fed. The depression 31 presents a certain structure on its bottom, which is transmitted to the energy absorption element 2 during the moulding of the supporting base, see also FIG. 3. This structure serves the corresponding shaping of the energy absorption element 2, for example, in order to adapt this to a corresponding shape of the body or to a space present between the roof liner and body. A shape preservation material 15 is applied to the energy absorption element 2. This material stabilises the shape of the energy absorption element 2 transmitted through the depression 31 during the moulding of the supporting base when the energy absorption element 2 is of elastically recovering material. The shape preservation material 15 can be an appropriate adhesive or reaction material, for example.

There is likewise the possibility that the depression 31 presents no further structure, but is instead level, so that the energy absorption element 2, after being loaded, rests directly on the bottom of the depression 31. The energy absorption element can also be prefabricated as a moulded part with a particular shaping.

The process steps described above are only exemplary and can be replaced by others. For example, the crash pads can also be loaded into an appropriate tool of the laminating machine and by this means be attached to the sandwich and optionally shaped. It is also possible to do without the first processing station 20 if an adhesive is contained in or applied to one of the layers to be joined.

FIG. 3 depicts a cut through a roof liner 1 manufactured according to the method according to the invention. At the same time, a corresponding shaping of the roof liner 1 is left out for simplification; see FIG. 1 in this regard, for example.

The roof liner 1 presents the core layer 3 of foam material 31. On its upper side 16 the reinforcement layer 4, formed of reinforcement matting 9 and cover matting 10, is applied. In the same way, a reinforcement layer 4 is applied to the bottom 17 of the core layer 3. Reinforcement matting 9 and cover matting 10 can contain fibres in a tangled arrangement or also in uni-directional alignment. Examples of such fibres are synthetically manufactured fibres such as glass fibres or fibres of natural materials such as linen, jute or the like. A weave, scrim or the like made of fibres can also be used. The above-mentioned fibres can be arranged in a matrix of an appropriate plastic material.

An energy absorption element 2 is attached to the reinforcement layer 4 that is mounted on the upper side 16, whereby the corresponding attachment and shaping of the energy absorption element 2 take place in the hot-press 13 according to FIG. 1. With an energy absorption element 2, a shape preservation material 15 is furthermore suggested on its exterior.

In one embodiment of the invention, the energy absorption element 2 can likewise be formed from a foam material, whereby this can be the same as the foam material 32 of the core layer 3. As a rule, the foam materials of the energy absorption element 2 and core layer 3 are, however, modified so that the softening temperature of the material of the energy absorption element 2 is less than the softening temperature of the material of the core layer 3. Polyurethane, polypropylene and other foams can be used as foams.

A decorative layer 6 is applied to the reinforcement layer 4 that is allocated to the lower side 7 of the core layer 3; see the laminating machine 27 according to FIG. 1 in this regard.

Likewise, for the energy absorption element, other materials or also particular structures are conceivable, such as a rib structure, honeycomb structure, ring structures or the like, for example, which are used both alone or also together with an appropriate foam.

1. Method for the manufacture of a roof liner (1) with at least one energy absorption element (2) using the following steps:
i) provision of a core layer, particularly a plate-shaped one;
ii) at least one-sided application of at least one reinforcement layer (4) on one side (16, 17) of the core layer (3);
iii) loading of the energy absorption element (2) into a moulding tool (5) and at least the joining of the energy absorption element (2) to the core layer (3) and/or the reinforcement layer (4) during moulding.

2. Method according to claim 1,
characterised by
the further step of the at least one-sided application of a decorative layer (6) on one side of a sandwich (14) made of at least a core layer (3) and a reinforcement layer (4).

3. Method according to claim 1 or 2,
characterised in that
the core layer (3) is permanently plastically shaped during the moulding in the moulding tool (5).

4. Method according to one of the preceding claims,
characterised in that
before step i), the core layer (3) is cut from a prefabricated core layer block.

5. Method according to one of the preceding claims,
characterised in that
the core layer (3) is foamed before step i).

6. Method according to one of the preceding claims,
characterised in that
step iii) is carried out before the application of the decorative layer (6) and subsequent to step ii).

7. Method according to one of the preceding claims,
characterised in that
subsequent to step i), an adhesive (7) and optionally water (8) are applied to the core layer (3).

8. Method according to one of the preceding claims,
characterised in that
in step ii), a two-layered reinforcement layer (4), particularly of reinforcement matting (9) and cover matting (10), is applied.

9. Method according to one of the preceding claims,
characterised in that
after application of the energy absorption element (2) in step iii) an adhesive (11) is applied to at least one side of the sandwich (14) formed, before application of the decorative layer (6).

10. Method according to one of the preceding claims,
characterised in that
before being applied to the sandwich (14), the decorative layer (6) is heated and subsequently laminated to the sandwich (14) in a laminating machine (12).

11. Method according to one of the preceding claims,
characterised by
simultaneous heat supply in step iii) during the moulding of the supporting base, inside a hot-press (13).

12. Method according to one of the preceding claims,
characterised in that
in step iii) the energy absorption element (2) is shaped and held in its shaped state by a shape preservation material (15).

13. Roof liner (1) with at least one energy absorption element (2) manufactured according to one of the claims 1 to 12,
characterised in that
the core layer is formed from a foamed material and the reinforcement layer (4) presents fibres, particularly in a tangled arrangement.

14. Roof liner according to claim 13,
characterised in that
the energy absorption element (2) is formed from an energy-absorbing, foamed material.

15. Roof liner according to claim 13 or 14,
characterised in that
the energy absorption element (2) presents at least one structure element or is formed from such an element.

16. Roof liner according to one of the claims 13 to 15,
characterised in that
the energy absorption element (2) and core layer (3) present the same foamed material.

17. Roof liner according to one of the claims 13 to 16,
characterised in that
the material of the energy absorption element (2) presents a lower softening temperature than does the material of the core layer (3).

18. Roof liner according to one of the preceding claims 13 to 17,
characterised in that
the core layer (3) with applied adhesive (7) is duroplastically workable.

19. Roof liner according to one of the preceding claims 13 to 18,
characterised in that
the adhesive (7) can be applied to both the top and bottom (16, 17) of the core layer (3) by an application device (18).
